(19) United States
(12) Patent Application Publication
(10) Pub. No.: US 2026/0048583 A1
(43) Pub. Date: Feb. 19, 2026

(54) MULTI-HEAD INKJET DEVICE DRIVE SYSTEM AND MULTI-HEAD INKJET DEVICE

(71) Applicant: CHIA-HSIANG HUNG, TAIPEI CITY (TW)

(72) Inventors: XINZHE JIANG, Kunshan City (CN); WEI ZHAO, Kunshan City (CN); RUI TIAN, Kunshan City (CN); PEIPEI PU, Kunshan City (CN); JIANMIN LI, Kunshan City (CN); YONG WANG, Kunshan City (CN); WENFENG SHUAI, Kunshan City (CN)

(21) Appl. No.: 19/297,007

(22) Filed: Aug. 12, 2025

(30) Foreign Application Priority Data
Aug. 13, 2024 (CN) 202411110125.X

(51) Int. Cl. B41J 2/045

(52) U.S. Cl. CPC B41J 2/04568; B41J 2/04543; B41J 2/0455; B41J 2/04573; B41J 2/04588; B41J 2/04591; B41J 2/04586

(57) ABSTRACT

The present disclosure relates to a drive system for a row-connected inkjet apparatus. The system comprises a main control board, a plurality of drive boards, corresponding groups of printing heads, synchronization modules, and communication modules. The main control board sends printing time-sequence synchronization information to each drive board via the synchronization modules and sends printing data via the communication modules. Each printing-head group responds to the drive signal from its corresponding drive board and simultaneously performs jet printing of its assigned portion of the data, thereby enabling rapid spliced printing. This configuration offers broad utility in achieving efficient and precise spliced printing.

### CROSS-REFERENCE TO RELATED APPLICATIONS

This application claims the benefit of Chinese Invention patent application No. 202411110125.X, filed on 13 Aug. 2024, the entire disclosure of which is hereby incorporated by reference.

### BACKGROUND

The present disclosure relates to the field of inkjet apparatuses, and in particular, to a drive system for a row-connected inkjet apparatus, and an inkjet apparatus.

A drop on demand (DOD) inkjet apparatus, whose scientific name is a valve-type inkjet apparatus, mainly uses compressed air to drive ink to be printed on a surface of a product. In comparison with another inkjet apparatus that needs to use ink corresponding to a principle of another inkjet apparatus, an existing DOD inkjet apparatus usually works independently and prints a character with a maximum width of 32 dots. If a wider character needs to be printed, the character needs to be printed back and forth after the DOD inkjet apparatus is transversely translated.

With expansion of application scenarios of the DOD inkjet apparatus, higher requirements are imposed on a printing scale and printing efficiency, and 32-dot printing is far from satisfying customer requirements. In the solution of back-and-forth printing, a function of transverse movement of a printing head needs to be added, which has low efficiency. In addition, operational conditions are complex, and a fault easily occurs. Printing precision is usually low, and it is difficult to implement a high-precision splicing and coordination operation.

The existing DOD inkjet apparatus usually includes a plurality of solenoid valves. The solenoid valves belong to a soft mechanical structure, and it is difficult to ensure delivery consistency. Therefore, it is necessary to set a drive waveform to ensure consistency of each point. The drive waveform includes a drive voltage and drive duration. A drive power of the DOD inkjet apparatus is large, and it is difficult to adjust the drive voltage. Therefore, the drive voltage is usually a fixed value at delivery. The waveform is changed mainly by adjusting the drive duration, to slightly adjust a printing effect. Consequently, it is difficult to fine control the printing head.

In an existing solution, only the drive duration can be adjusted to set the drive waveform. Consequently, an adjustment capability is limited. As a result, an adaptive operating condition is greatly limited, and expansion of application scenarios is affected. The existing DOD inkjet apparatus can print by using ink of different viscosities. However, due to different characteristics such as viscosities and surface tensions of different ink, a manufacturer usually needs to adjust a parameter of the inkjet apparatus on site based on an ink specification of a customer. When the ink is changed, the manufacturer further needs to perform on-site adjustment again, resulting in a waste of time and energy, and poor matching and adaption between an ink viscosity and a surface tension.

### SUMMARY

To resolve one of the foregoing problems, this application provides a drive system for a row-connected inkjet apparatus, and an inkjet apparatus, which have at least an effect of implementing spliced printing, or implementing adaptability to different printing materials, or implementing quick start and blocking removal of a printing head, or reducing power consumption and controlling a problem of high power consumption, or resolving a problem of fine control of a printing head.

The present disclosure includes the following content:

Implementation 1: A drive system for a row-connected inkjet apparatus is provided. The system includes a main control board, a plurality of drive boards, a plurality of groups of printing heads corresponding to the plurality of drive boards, a plurality of synchronization modules, a plurality of communication modules, and an upper machine.

The main control board sends, to the plurality of drive boards by using the plurality of synchronization modules, synchronization information of printing time sequences for controlling the plurality of groups of printing heads.

The main control board sends printing data to the plurality of drive boards by using the plurality of communication modules.

Each of the plurality of drive boards receives the synchronization information of the printing time sequences and a corresponding part of the printing data that are sent by the main control board, and outputs a drive signal to a corresponding printing head based on the synchronization information of the printing time sequences and the corresponding part of the printing data that are received.

Each of the plurality of groups of printing heads responds to the drive signal outputted by the corresponding drive board, and simultaneously performs jet printing for the corresponding part of the printing data, to implement quick spliced printing.

Implementation 2: In the drive system for the row-connected inkjet apparatus according to Implementation 1, the main control board controls 2 to 40 synchronization modules and 2 to 40 communication modules, a quantity of the plurality of drive boards ranges from 2 to 40, and a quantity of the plurality of groups of printing heads ranges from 2 to 40, to print a character whose width exceeds 32 dots.

Implementation 3: In the drive system for the row-connected inkjet apparatus according to Implementation 1, the printing data includes a setting parameter, an adjustment parameter, an inkjet speed, character data, verified data, time sequence information, and a picture; and the drive signal includes a drive voltage.

Implementation 4: In the drive system for the row-connected inkjet apparatus according to Implementation 3, a range of the adjustment parameter is at least one or more combinations of number information of the printing heads, adjustment information of a spacing between the printing heads, printing delay information of the printing heads, the time sequence information, and printing direction information of the printing heads, to implement alignment, synchronization, or consistency of the printing data.

Implementation 5: In the drive system for the row-connected inkjet apparatus according to any one of Implementations 1 to 4, the inkjet speeds of the plurality of groups of printing heads are adjustable, to control a spacing between characters printed by each group of printing heads.

Implementation 6: The drive system for the row-connected inkjet apparatus according to any one of Implementations 1 to 4 further includes the upper machine. The upper machine is connected to or in data communication with the main control board. The main control board is connected to the plurality of drive boards. The plurality of drive boards are connected to the plurality of corresponding groups of printing heads. The synchronization modules and the communication modules are integrated on the main control board.

Implementation 7: In the drive system for the row-connected inkjet apparatus according to any one of Implementations 1 to 4, the plurality of drive boards perform printing control based on level signals in the synchronization modules, and the level signals of the plurality of drive boards are sent by the same main control board.

Implementation 8: In the drive system for the row-connected inkjet apparatus according to any one of Implementations 1 to 7, the drive board includes a plurality of pulse-width modulators, a plurality of waveform switching circuits (or waveform selectors), a plurality of drive circuits, and a control-signal output circuit.

The plurality of pulse-width modulators respectively output different pulse waveforms, and each of the pulse-width modulators is connected to all the waveform switching circuits.

The plurality of waveform switching circuits select or switch a pulse waveform from the plurality of pulse-width modulators based on control information provided by the control-signal output circuit, and provide the pulse waveform as a drive waveform to a corresponding drive circuit, to enable the drive circuit to drive, based on the drive waveform, a corresponding printing head to perform a printing operation.

Implementation 9: In the drive system for the row-connected inkjet apparatus according to Implementation 8, the control information includes information about a time point and a corresponding pulse-width modulator, to enable the waveform switching circuit to switch, at the time point, the drive waveform to a pulse waveform provided by the corresponding pulse modulation. Each pulse waveform is a square wave.

Implementation 10: In the drive system for the row-connected inkjet apparatus according to Implementation 8, the plurality of pulse-width modulators include three pulse-width modulators, and the three pulse-width modulators respectively output three different pulse waveforms, including a start waveform, a retaining waveform, and a release waveform. A duty cycle of the start waveform is greater than a duty cycle of the retaining waveform, and the release waveform is an inverse waveform.

Implementation 11: In the drive system for the row-connected inkjet apparatus according to Implementation 8, the different pulse waveforms are square waves with different duty cycles.

Implementation 12: In the drive system for the row-connected inkjet apparatus according to Implementation 8, the different pulse waveforms include at least a waveform 1, a waveform 2, and a waveform 3. The waveform 1 is a waveform whose duty cycle is greater than or equal to 70% and less than or equal to 100%. The waveform 2 is a waveform whose duty cycle is greater than or equal to 10% and less than or equal to 30%. The waveform 3 is an inverse waveform whose duty cycle is greater than or equal to 10% and less than or equal to 30%. A negative bias is used to accelerate resetting of the printing head.

Implementation 13: In the drive system for the row-connected inkjet apparatus according to Implementation 8, a viscosity of ink corresponding to the waveform ranges from 1 cps to 1000 cps, and a surface tension of the corresponding ink ranges from 20 mN/m to 70 mN/m.

Implementation 14: In the drive system for the row-connected inkjet apparatus according to Implementation 8, the three pulse-width modulators respectively output pulse waveforms to 8 to 40 waveform switching circuits; and the control-signal output circuit provides 8 to 40 pieces of different control information and respectively sends the control information to the 8 to 40 waveform switching circuits.

Implementation 15: In the drive system for the row-connected inkjet apparatus according to any one of Implementations 8 to 12, the plurality of pulse-width modulators include a pulse-width modulator that outputs a high-frequency waveform to increase a frequency and a width of a pulse, or outputs a waveform whose duty cycle is greater than 98% to improve energy output of the printing head, so that when the printing head is blocked, the waveform of the pulse-width modulator is used to shock the printing head to remove blocking.

Implementation 16: In the drive system for the row-connected inkjet apparatus according to any one of Implementations 8 to 12, the plurality of pulse-width modulators at least use a pulse-width modulation chip. The plurality of waveform switching circuits at least use an integrated analog switch. The plurality of drive circuits at least use a driver. The plurality of groups of printing heads at least use a MOS transistor. An output pin of the pulse-width modulation chip is connected to an input pin of the integrated analog switch. An output pin of the integrated analog switch is connected to an input pin of the driver. An output pin of the driver is connected to a gate of the MOS transistor. A drain of the MOS transistor is connected to the plurality of groups of printing heads.

Implementation 17: In the drive system for the row-connected inkjet apparatus according to any one of Implementations 8 to 12, the printing head controls a working status of the printing head by using a built-in solenoid valve, and the control-signal output circuit communicates with the upper machine.

This application has at least one of the following effects.

In this application, the main control board includes the synchronization modules, to control the drive boards, so that the plurality of drive boards can be synchronously operated when printing is driven. A plurality of devices can synchronously work, to implement a high-precision spliced printing operation. Specifically, printing data is divided into a plurality of pieces and respectively provided to each of the drive boards, and the plurality of devices are synchronously controlled to simultaneously print a corresponding part of the data. Further, independent and fine spraying-head controlling performed by using the waveform is implemented, problems that duration control is limited and it is difficult to control a current and a voltage are resolved, and independent spraying-head controlling that is fine or consistent is implemented.

Further, an effect of spliced printing is further optimized, to overcome a defect of transverse translation for back-and-forth printing or imprecision in the existing technology. The main control board simultaneously manages the printing time sequences of the plurality of block drive boards, so that misplacement of a printing location caused by asynchronized clocks of the different drive boards is avoided. The main control board can synchronously control the printing time sequences of the plurality of drive boards, to ensure stable and efficient running of an entire printing process.

Further, the main control board, the communication modules, and the synchronization modules of the drive system relate to repeated data adjustment and processing of a plurality of times.

Further, an effect of spliced printing that is aligned, synchronous, or consistent can be achieved. Further, the spacing between the selected printing heads is adjusted, the printing direction of the selected printing heads is adjusted, and the spacing between the printing heads is adjusted to control characters printed by the different printing heads to be consistent, thereby ensuring that the characters printed by the plurality of groups of printing heads are aligned and not offset.

Further, the main control board sends, to the plurality of drive boards, the printing data set based on adjusted parameters. This step is mainly to control a left-right spacing between characters by adjusting an inkjet speed, where a larger inkjet speed indicates a smaller left-right spacing between the characters, and a smaller inkjet speed indicates a larger left-right spacing between the characters. Inkjet speeds of the plurality of groups of printing heads are adjusted to be consistent, so that spacings between characters printed by each group of printing heads are consistent.

Further, the communication modules on the main control board perform data verification with the drive boards aperiodically. Once a large fluctuation occurs, the system alarms, and finds a problem in time, to avoid a subsequent loss.

A further effect further includes adaptability to different printing materials, to implement quick start and blocking removal of the printing head, or reduce power consumption and control a problem of high power consumption. Especially, when the printing head is blocked, the waveform switching circuit selects the start waveform or the retaining waveform based on an actual situation, to implement applicability to different printing materials, so as to improve compatibility of a printer printing head and a printing effect. During actual application, the switching circuit needs to automatically select an appropriate waveform based on factors such as a characteristic of a printing material and a blocking degree of the printing head, to ensure printing quality.

A low duty cycle is used to reduce power consumption, so that an energy saving effect is achieved. If it is difficult to achieve the energy saving effect through voltage and current control in the existing technology, the low duty cycle reduces the power consumption, reduces heat generation, and increases life. Alternatively, the release waveform drives the printing head to generate a release signal, where resetting of the printing head is accelerated by using the negative bias, to generate the release signal, so that a working frequency is increased.

In addition, the technical solutions of the present disclosure further bring many other advantages, and these advantages are described in detail in specific implementations.

It should be understood that the foregoing general descriptions and the following detailed descriptions are only exemplary, and cannot limit the present disclosure.

### BRIEF DESCRIPTION OF THE DRAWINGS

To describe the technical solutions in embodiments of the present disclosure more clearly, the following briefly describes the accompanying drawings of the embodiments. It is clear that the accompanying drawings in the following descriptions relate to merely some embodiments of the present disclosure, and are not a limitation to the present disclosure.

FIG. 1 is a schematic diagram of a drive system for a row-connected inkjet apparatus according to an embodiment of this application;

FIG. 2 is a schematic diagram of synchronization of adjusting a printing time sequence according to an embodiment of this application;

FIG. 3 is a schematic diagram of synchronization of adjusting a printing time sequence according to another embodiment of this application; and

FIG. 4 is a schematic diagram of circuit control of a drive board in a drive system according to this application.

### DETAILED DESCRIPTION

At present, the exemplary embodiments are described comprehensively with reference to the accompanying drawings. However, the exemplary embodiments can be implemented in a plurality of forms, and it should not be understood as being limited to the embodiments described herein. Instead, the embodiments are provided to make the present disclosure more comprehensive and complete, and fully convey the ideas of the exemplary embodiments to a person skilled in the art. A same reference numeral in the accompanying drawings represents same or similar components, and therefore repeated descriptions of the components are appropriately omitted.

In addition, the described features, structures or characteristics may be combined in one or more embodiments in any appropriate manner. In the following descriptions, a lot of specific details are provided to give a comprehensive understanding of the embodiments of the present disclosure. However, a person of ordinary skill in the art is to be aware that, the technical solutions in the present disclosure may be implemented without one or more of the particular details, or another method, unit, apparatus, or step may be used. In other cases, well-known methods, apparatuses, implementations, or operations are not shown or described in detail, in order not to obscure the aspects of the present disclosure.

Related technical terms in this application are described without special descriptions in this application, and “control information” and “a control signal” are the same technical terms, and “providing by a pulse-width modulator” and “outputted by a pulse-width modulator” are a same technical term.

In this application, “DOD inkjet” and “valve-type inkjet” belong to a same term.

An aspect of this application provides a drive system for a row-connected inkjet apparatus. The system includes a main control board, a plurality of drive boards, a plurality of groups of printing heads corresponding to the plurality of drive boards, a plurality of synchronization modules, a plurality of communication modules, and an upper machine.

The main control board sends, to the plurality of drive boards by using the plurality of synchronization modules, synchronization information of printing time sequences for controlling the plurality of groups of printing heads.

The main control board sends printing data to the plurality of drive boards by using the plurality of communication modules. Each of the plurality of drive boards receives the synchronization information of the printing time sequences and a corresponding part of the printing data that are sent by the main control board, and outputs a drive signal to a corresponding printing head based on the synchronization information of the printing time sequences and the corresponding part of the printing data that are received.

Each of the plurality of groups of printing heads responds to the drive signal outputted by the corresponding drive board, and simultaneously performs jet printing for the corresponding part of the printing data, to implement quick spliced printing. In this application, the main control board controls the drive boards by using the synchronization modules, so that the plurality of drive boards can be synchronously operated when printing is driven. A plurality of devices can synchronously work, to implement a high-precision spliced and coordinated printing operation. Specifically, printing data is divided into a plurality of pieces and respectively provided to each of the drive boards, and the plurality of devices are synchronously controlled to simultaneously print a corresponding part of the data. Further, independent and fine spraying-head controlling performed by using the waveform is implemented, problems that duration control is limited and it is difficult to control a current and a voltage are resolved, and independent controlling that is fine or consistent is implemented.

In some implementations, the main control board controls 2 to 40 synchronization modules and 2 to 40 communication modules, a quantity of the drive boards ranges from 2 to 40, and a quantity of the printing heads ranges from 2 to 40, to print a character whose width exceeds 32 dots. An effect of spliced printing is further optimized, including implementing printing of the character whose width exceeds 32 dots, to overcome a defect of transverse translation for back-and-forth printing or imprecision in the existing technology. Further, the main control board simultaneously manages the printing time sequences of the plurality of block drive boards, so that misplacement of a printing location caused by asynchronized clocks of the different drive boards is avoided. The main control board can synchronously control the printing time sequences of the plurality of drive boards, to ensure stable and efficient running of an entire printing process.

In some implementations, the printing data includes a setting parameter, an adjustment parameter, an inkjet speed, character data, verified data, time sequence information, and a picture; and the drive signal includes a drive voltage. The main control board, the communication modules, and the synchronization modules of the drive system relate to repeated data adjustment and processing of a plurality of times.

In some implementations, a range of the adjustment parameter is at least one or more combinations of number information of the printing heads, adjustment information of a spacing between the printing heads, printing delay information of the printing heads, the time sequence information, and printing direction information of the printing heads, to implement alignment, synchronization, or consistency of the printing data. For an effect of aligned, synchronous, or consistent printing, further, the spacing between the selected printing heads is adjusted, the printing direction of the selected printing heads is adjusted, and the spacing between the printing heads is adjusted to control characters printed by the different printing heads to be consistent, thereby ensuring that the characters printed by the plurality of groups of printing heads are aligned and not offset.

In some implementations, the upper machine is connected to or in data communication with the main control board. The main control board is connected to the plurality of drive boards. The plurality of drive boards are connected to the plurality of corresponding groups of printing heads. The synchronization modules and the communication modules are integrated on the main control board.

In some implementations, the plurality of drive boards perform printing control based on high-frequency level signals in the synchronization modules on the main control board, and the level signals of the plurality of drive boards are sent by the same main control board. The communication modules on the main control board perform data verification with the drive boards aperiodically. Once a large fluctuation occurs, the system alarms, and finds a problem in time, to avoid a subsequent loss.

Implementation presentation of the main control board further includes the communication modules and the synchronization modules. The main control board sends the synchronization information of the printing time sequences to the plurality of drive boards by using the synchronization modules. The main control board sends, by using the communication modules, printing data of parameter setting, picture downloading, and data reading to the plurality of drive boards. The plurality of drive boards receive the synchronization information of the printing time sequences and the printing data that are sent by the main control board, and sends character data in the synchronization information of the printing time sequences and the printing data. Specifically, the plurality of drive boards send information about the printing time sequences to the plurality of groups of printing heads. The plurality of groups of printing heads simultaneously and synchronously print the character data. The plurality of groups of printing heads receive the synchronization information of the printing time sequences and the character data that are sent by the plurality of drive boards in one-to-one correspondence with the printing heads, and simultaneously perform jet printing for the character data. A quantity of printing heads mounted in each of the plurality of groups of printing heads may be one or more. The main control board calculates the printing time sequences of the drive boards based on a printing parameter and picture data that are set by a user, and sends the information about the calculated printing time sequences to the drive boards. The drive boards control movement and an inkjet operation of the printer printing heads based on the information about the printing time sequences, to implement synchronous printing.

The main control board sends, to the plurality of drive boards, the printing data set based on adjusted parameters. This step is mainly at least reflected by controlling a left-right spacing between characters by adjusting an inkjet speed, where a larger inkjet speed indicates a smaller left-right spacing between the characters, and a smaller inkjet speed indicates a larger left-right spacing between the characters. Inkjet speeds of the plurality of groups of printing heads are adjusted to be consistent, so that spacings between characters printed by each group of printing heads are consistent. The main control board can synchronously control the printing time sequences of the plurality of drive boards, to ensure stable and efficient running of an entire printing process. In addition, the main control board can further monitor working statuses of the drive boards in real time, to ensure normal running of a printing device.

A communication manner of the communication module on the main control board may be wired or wireless communication, such as USB, the Ethernet, or Wi-Fi.

The communication modules on the main control board collect the working statuses of the plurality of drive boards in real time. When all the drive boards are ready, the communication modules send a start command, and add data verification or verified data, thereby ensuring data reliability. However, in consideration of a possible delay or block during communication, the drive board performs a printing operation based on a high-frequency TTL signal (level signal) of the synchronization module on the main control board. In addition, because TTL signals of the plurality of drive boards are sent by the same main control board, asynchronous printing caused by different clock signals between different board cards can be avoided. The TTL signal is easy to be interfered. The communication modules on the main control board perform data verification with the drive boards aperiodically. Once a large fluctuation occurs, the system alarms, and finds a problem in time, to avoid a subsequent loss. Preferably, the drive system for the row-connected inkjet apparatus is a highly integrated control system, and is mainly used to control a printing head in an inkjet printing device. The printing head preferably includes a plurality of groups of high-precision intelligent micro valves. During jet printing, a character or pattern on which jet printing is to be performed is processed by using a computer mainboard, that is, the host computer. The main control board outputs a series of electrical signals, and quickly starts the intelligent micro solenoid valves by using the communication modules and the drive boards. Ink is formed into ink spots by an internal constant pressure, and sprayed out. The ink spots form the character or pattern on a surface of a moving printed matter.

The main control board sends a parameter setting instruction to each of the drive boards, for example, adjusting parameters such as a working frequency of the printing heads, an inkjet speed, and a spraying amount, to ensure that working statuses of the groups of printing heads are consistent. When to-be-printed content needs to be replaced, the main control board may transmit, for example, new picture or character data to each of the drive boards by using the communication modules, to update the to-be-printed content. The main control board may read information such as the working status and printing quality data from each of the drive boards by using the communication modules, to monitor and adjust a system operating condition. Therefore, the main control board performs data communication with the drive boards by using the communication modules, to implement centralized control and management on the plurality of drive boards, thereby ensuring the consistent working statuses of the plurality of groups of printing heads, and effectively managing the entire drive system for the row-connected inkjet apparatus.

A DOD printing head usually requires precise voltage control to control inkjet spraying, and the drive board is responsible for providing a voltage drive signal. The drive board precisely controls, by using an internal circuit and controller, the outputted voltage drive signal based on an instruction sent by the main control board. The voltage signal directly acts on an inkjet system in the printing head, thereby precisely controlling inkjet. In addition, the drive board further includes functions of regulating and protecting a voltage output, to ensure that the printing head can work stably in a suitable voltage range. The drive board provides a precise drive voltage to the printing head, to precisely control inkjet, thereby ensuring quality and stability of jet printing.

The main control board controls the drive boards by using the synchronization modules, mainly to synchronize the time sequences of the plurality of drive boards in the printing process. The main control board send a control signal to the drive board, to ensure that each of the drive boards can work based on the predetermined time sequence and parameter when printing is driven. This synchronization control manner can improve printing precision and efficiency, and avoid a printing error and fault caused by asynchronization.

The main control board sends a time sequence control signal such as start, stop, acceleration, or deceleration to the drive board based on a requirement of a printing task, to ensure that the drive boards are synchronized in the printing process. Printing data, such as a paper feeding speed and a spacing between the printing heads, needs to be transmitted between the main control board and the drive board in real time. The synchronization modules ensure accurate data transmission, to implement coordinated working of the drive boards. The main control board controls the drive boards by using the synchronization modules, to implement synchronous operation of the plurality of drive boards when printing is driven, so that precision and consistency of simultaneous jet printing performed by the plurality of groups of printing heads, are ensured, inkjet efficiency is improved, and a large-scale jet printing requirement is satisfied. The synchronization module further has a fault detection function. Once it is discovered that the drive board works abnormally, the main control board immediately takes measures to perform processing, such as stopping printing or alarming, to ensure safety and reliability of the printing process.

In some implementations, the drive board of the drive system includes a plurality of pulse-width modulators, a plurality of waveform switching circuits, a plurality of drive circuits, and a control-signal output circuit.

The plurality of pulse-width modulators respectively output different pulse waveforms, and each of the pulse-width modulators is connected to all the waveform switching circuits.

The plurality of waveform switching circuits select or switch a pulse waveform from the plurality of pulse-width modulators based on control information provided by the control-signal output circuit, and provide the pulse waveform as a drive waveform to a corresponding drive circuit, to enable the drive circuit to drive, based on the drive waveform, a corresponding printing head to perform a printing operation. Therefore, independent and fine spraying-head controlling performed by using the waveform is implemented, problems that duration control is limited and it is difficult to control a current and a voltage are resolved. A further effect is adaptability to different printing materials, to further implement quick start and blocking removal of the printing head, or reduce power consumption and control a problem of high power consumption.

In some implementations, the control information includes information about a time point and a corresponding pulse-width modulator, to enable the waveform switching circuit to switch, at the time point, the drive waveform to a pulse waveform provided by the corresponding pulse modulation. Each pulse waveform is a square wave.

In some implementations, the plurality of pulse-width modulators include three pulse-width modulators, and the three pulse-width modulators respectively output three different pulse waveforms, including a start waveform, a retaining waveform, and a release waveform. A duty cycle of the start waveform is greater than a duty cycle of the retaining waveform, and the release waveform is a inverse waveform, so that waveform drive signals of different drive phases are provided. The start waveform drives the printing head to generate a start signal for starting the printing head. The retaining waveform drives the printing head to retain working stably, to generate a retaining signal for retaining working of the printing head. The release waveform drives the printing head to generate a release signal.

In some implementations, the different pulse waveforms are square waves with different duty cycles. The duty cycles and cycles of the waveforms outputted by using the three pulse-width modulators may be independently set to improve flexibility and efficiency of waveform control. In some implementations, the different pulse waveforms include at least a waveform 1, a waveform 2, and a waveform 3. The waveform 1 is a waveform whose duty cycle is greater than or equal to 70% and less than or equal to 100%, and may be used as the start waveform. The waveform 2 is a waveform whose duty cycle is greater than or equal to 10% and less than or equal to 30%, and may be used as the retaining waveform. The waveform 3 is an inverse waveform whose duty cycle is greater than or equal to 10% and less than or equal to 30%, and may be used as the release waveform. A negative bias is used to accelerate resetting of the printing head, to represent an energy saving effect of this application. The energy saving effect is achieved through waveform control. If it is difficult to achieve the energy saving effect through voltage and current control in the existing technology, specifically, a duty cycle and energy output are high, the low duty cycle reduces the power consumption, reduces heat generation, and increases life. The negative bias can accelerate resetting of the printing head and increase a working frequency. Resetting of the printing head is accelerated by using the negative bias, to generate the release signal for releasing the printing head. A high-frequency waveform may be the retaining waveform or the start waveform. When a high-frequency waveform used when a blockage is strongly sprayed is the start waveform, the high-frequency waveform is used to excite or activate liquid in a nozzle, so that the liquid quickly forms a high-velocity sprayed fluid. Energy provided by the high-frequency waveform sharply compresses and expands the liquid, to form a high-velocity jet, thereby effectively clearing the blockage.

In some implementations, a viscosity of ink corresponding to the waveform ranges from 1 cps to 1000 cps, and a surface tension of the ink ranges from 20 mN/m to 70 mN/m. When the high-frequency waveform retains the waveform, characteristics of a signal, such as a frequency, an amplitude, and a phase, are retained in a transmission process. Parameters (such as the frequency, the amplitude, and the shape) of the high-frequency waveform are adjusted, so that performance of the sprayed liquid can be optimized, spraying efficiency is improved, and efficiency of clearing the blockage is improved. The high-frequency waveform can increase a spacing between molecules in the liquid, thereby reducing a viscosity of the liquid and improving flow performance of the liquid.

In some implementations, the three pulse-width modulators respectively output pulse waveforms to 8 to 40 waveform switching circuits; and the control-signal output circuit provides 8 to 40 pieces of different control information and respectively sends the control information to the 8 to 40 waveform switching circuits.

In some implementations, the plurality of pulse-width modulators include a pulse-width modulator that outputs a high-frequency waveform to increase a frequency and a width of a pulse, or outputs a waveform whose duty cycle is greater than 98% to improve energy output of the printing head, so that when the printing head is blocked, the waveform of the pulse-width modulator is used to shock the printing head to remove blocking. When the printing head is blocked by a printing material, the pulse-width modulator outputs the high-frequency waveform to increase the frequency and the width of the pulse, and increases the duty cycle to improve the energy output of the printing head, so that the blockage is shocked and removed from a jet hole, thereby achieving a waveform pulse blocking removal effect of the present disclosure.

In some implementations, the plurality of pulse-width modulators at least use a pulse-width modulation chip. The plurality of waveform switching circuits at least use an integrated analog switch. The plurality of drive circuits at least use a driver. The plurality of groups of printing heads at least use a MOS transistor. An output pin of the pulse-width modulation chip is connected to an input pin of the integrated analog switch. An output pin of the integrated analog switch is connected to an input pin of the driver. An output pin of the driver is connected to a gate of the MOS transistor. A drain of the MOS transistor is connected to the plurality of groups of printing heads.

In some implementations, the printing head preferably controls a working status of the printing head by using a built-in solenoid valve, and the control-signal output circuit communicates with the host computer.

This application is more specifically exemplified by using the following embodiments.

### EMBODIMENT

### Embodiment 1

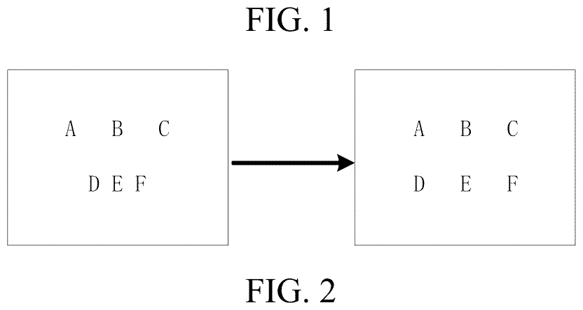

FIG. 1 is a schematic diagram of a drive system for a row-connected inkjet apparatus. The drive system for the row-connected inkjet apparatus provided in this embodiment of this application includes a main control board 1, a plurality of drive boards such as 2-1, . . . , and 2-16, a plurality of groups of printing heads 4, such as 4-1, . . . , and 4-16, corresponding to the plurality of drive boards, a plurality of synchronization modules such as 5-1, . . . , and 5-16, a plurality of communication modules such as 04-1, . . . , and 04-16, and a host computer 6.

The main control board 1 sends, to the plurality of drive boards such as 2-1, . . . , and 2-16 by using the plurality of synchronization modules such as 5-1, 5-2, . . . , and 5-16, synchronization information of printing time sequences for controlling the plurality of groups of printing heads such as 4-1, . . . , and 4-16.

The main control board 1 sends printing data to the plurality of drive boards such as 2-1, . . . , and 2-16 by using the plurality of communication modules such as 04-1 and 04-2.

Each of the plurality of drive boards, such as 2-1 and 2-2, receives the synchronization information of the printing time sequences and a corresponding part of the printing data that are sent by the main control board 1, and outputs a drive signal to a corresponding group of printing heads, such as 4-1 and/or 4-2, in the plurality of groups of printing heads based on the synchronization information of the printing time sequences and the corresponding part of the printing data that are received.

Each of the plurality of groups of printing heads responds to the drive signal outputted by the corresponding drive board, and simultaneously performs jet printing for to-be-printed character in the corresponding part of the printing data, to implement quick spliced printing.

The printing data includes a setting parameter, an adjustment parameter, an inkjet speed, character data, verified data, time sequence information, and a picture; and the drive signal includes a drive voltage.

A connection relationship between the modules involved in the drive system is as follows:

The host computer 6 is connected to or in data communication with the main control board 1. The main control board 1 is connected to the plurality of drive boards such as 2-1, . . . , and 2-16. The plurality of drive boards such as 2-1, . . . , and 2-16 are connected to the plurality of corresponding groups of printing heads such as 4-1, . . . , and 4-16. The synchronization modules 04 and the communication modules 5 are integrated on the main control board 1. Preferably, the drive system further includes a power supply module 7, configured to be connected to the main control board 1 and provide working power for the main control board 1. The power supply module 7 is further configured to be connected to the drive boards such as 2-1, . . . , and 2-16, to provide working power for the drive boards and the printing heads.

The communication modules and the synchronization modules are integrated on the main control board. The foregoing drive system for the row-connected inkjet apparatus further includes the upper unit, configured to perform data communication with the main control board through an Ethernet interface, and send the printing information of parameter setting, picture downloading, and data reading.

In this embodiment, it is preferable that the system of this application simultaneously controls 16 synchronization modules and 16 communication modules, to describe implementation of transverse-translation spliced printing or back-and-forth spliced printing. The main control board controls the corresponding 16 synchronization modules and communication modules, includes 16 drive boards, and includes 16 printing heads for performing printing based on a requirement of the synchronization information and the corresponding printing data, to print a character whose width exceeds 32 dots, thereby overcoming a defect of imprecise transverse translation for back-and-forth printing in the existing technology. In this application, transverse translation of at least 16 groups of printing heads may be controlled, to print the character whose width exceeds 32 dots, and the transverse translation printing performed by simultaneously controlling the at least 16 groups of printing heads cannot be implemented by a single inkjet apparatus. Therefore, for an effect of this solution, the main control board simultaneously manages printing time sequences of the 16 groups of printing heads, so that misplacement of a printing location caused by asynchronized clocks of the different drive boards is avoided. The main control board can synchronously control the printing time sequences of the plurality of drive boards, to ensure stable and efficient running of an entire printing process. The main control board is added, and communications and a signal synchronization technology are optimized, so that a high-precision spliced and coordinated jet printing operation of a plurality of inkjet apparatuses is implemented.

Linkage of the communication module and the synchronization module in this application can implement spliced printing of up to 16 inkjet devices, so that an application range is greatly expanded One main control board is added, so that printing parameters of the 16 drive boards may be set by using the host computer with only one communications interface.

This solution of this embodiment of this application has one of the following effects.

In this application, the main control board controls the drive boards by using the synchronization modules, so that the plurality of drive boards can be synchronously operated when printing is driven. A plurality of devices can synchronously work, to implement a high-precision spliced and coordinated operation. Specifically, printing data is divided into a plurality of pieces and respectively provided to each of the drive boards, and the plurality of devices are synchronously controlled to simultaneously print a corresponding part of the data, thereby forming a character corresponding to the printing data.

Further, an effect of spliced printing is further optimized, to overcome a defect of imprecise transverse translation for back-and-forth printing in the existing technology. Further, the main control board simultaneously manages the printing time sequences of the plurality of block drive boards, so that misplacement of a printing location caused by asynchronized clocks of the different drive boards is avoided. The main control board can synchronously control the printing time sequences of the plurality of drive boards, to ensure stable and efficient running of an entire printing process. The main control board, the communication modules, and the synchronization modules of the drive system relate to repeated data adjustment and processing of a plurality of times. Further, the communication modules on the main control board perform data verification with the drive boards aperiodically. Once a large fluctuation occurs, the system alarms, and finds a problem in time, to avoid a subsequent loss.

### Embodiment 2

This embodiment shows control of consistent printing spacings of the plurality of groups of printing heads. FIG. 2 is a schematic diagram of synchronization of adjusting a printing time sequence according to an embodiment of this application. Characters ABC are printed by the printing head 4-1, and characters DEF are printed by the printing head 4-2. Because inkjet speeds of the two groups of printing heads are inconsistent, spacings between two rows of characters obtained through jet printing are inconsistent. The spacings between the characters obtained through jet printing are consistent by adjusting inkjet speeds of the printing heads. The main control board sends, to the drive board 2-2, printing data set based on an adjusted parameter of the inkjet speed of the printing head 4-2. The drive board 2-2 receives the printing data that is set based on the adjusted parameter and that is sent by the main control board. The drive board calculates a spacing between adjusted character data DEF based on the set parameter of the inkjet speed of the printing head 4-2, and sends the adjusted character data in the printing data. The printing head synchronously performs jet printing for the adjusted character data based on the received adjusted character data, and adjusts the parameter of the inkjet speed, to achieve consistent spacings between the printing data (ABC and DEF). A range of the adjustment parameter is at least one or more combinations of number information of the printing heads, adjustment information of a spacing between the printing heads, printing delay information of the printing heads, the time sequence information, and printing direction information of the printing heads, to implement alignment, synchronization, or consistency of the printing data. The inkjet speeds of the plurality of groups of printing heads are adjustable, to control a spacing between characters printed by each group of printing heads.

Preferably, the host computer is connected to or in data communication with the main control board. The main control board is connected to the plurality of drive boards. The plurality of drive boards are connected to the plurality of corresponding groups of printing heads. The synchronization modules and the communication modules are integrated on the main control board.

The main control board sends, to the plurality of drive boards, the printing data set based on the adjusted parameter. The plurality of drive boards receive the printing data that is set based on the adjusted parameter and that is sent by the main control board, calculates spacing data of adjusted character data in the printing data, and sends the adjusted character data in the printing data. The plurality of groups of printing heads performs jet printing for the adjusted character data based on the received adjusted character data.

The main control board sends, to the plurality of drive boards, the printing data set based on adjusted parameters. This step is mainly to control a left-right spacing between characters by adjusting an inkjet speed, where a larger inkjet speed indicates a smaller left-right spacing between the characters, and a smaller inkjet speed indicates a larger left-right spacing between the characters. Inkjet speeds of the plurality of groups of printing heads are adjusted to be consistent, so that spacings between characters printed by each group of printing heads are consistent.

### Embodiment 3

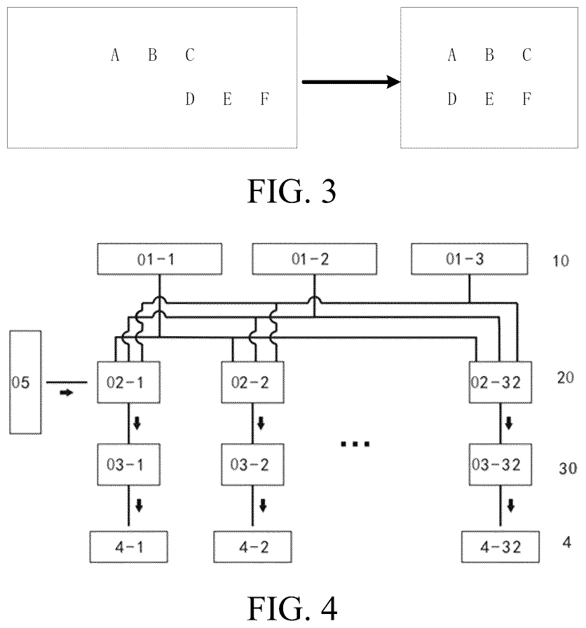

This embodiment shows alignment or non-offset of the printing data of the plurality of groups of printing heads. FIG. 3 is a schematic diagram of synchronization of adjusting a printing time sequence according to this application. For example, characters ABC are printed by the printing head 4-3, and characters DEF are printed by the printing head 4-4. The characters printed by the printing head 4-3 and the characters printed by the printing head 4-4 are not aligned. Therefore, when the characters ABC are adjusted to be aligned with the characters DEF, after the main control board sends, to the plurality of drive boards, the printing data set based on the adjusted parameter, that is, for adjusting a spacing of the printing head 4-4, the drive board selects, based on the printing data set based on the adjusted parameter, the printing head 4-4 from the plurality of groups of printing heads for jet printing, and sends, to the drive board 2-4, number information 4-4 of the selected printing head, information that the spacing of the printing head 4-4 is adjusted to 300, and information that a printing direction selection manner of the printing head 4-4 is, for example, reverse printing, so that the characters ABC obtained through jet printing performed by the printing head 4-3 are aligned with the characters DEF obtained through jet printing performed by the printing head 4-4.

Duration of spraying out the character by the inkjet apparatus is consistent with a speed of a carousel, so that a size of the character obtained through jet printing is not affected due to instability of the speed of the carousel.

In the foregoing step, a printing head is selected from the plurality of groups of printing heads to perform jet printing, the spacing between the selected printing heads is adjusted, the printing direction of the selected printing heads is adjusted, and the spacing between the printing heads is adjusted to control characters printed by the different printing heads to be consistent, thereby ensuring that the character data printed by the plurality of groups of printing heads are aligned or not offset.

### Embodiment 4

This embodiment shows a method of a drive procedure of a drive system for a valve-type inkjet apparatus. The method includes the following steps.

Step 1: The main control board 1 sends printing data, such as picture downloading and data reading, to the plurality of drive boards such as 2-1, . . . , and 2-16 by using the plurality of communication modules 04.

Step 2: The main control board 1 sends, to the plurality of drive boards such as 2-1, . . . , and 2-16 by using the plurality of synchronization modules 5, synchronization information of printing time sequences for controlling the plurality of groups of printing heads 4.

Step 3: Each of the plurality of drive boards 2, such as 2-1, receives the synchronization information of the printing time sequences and a corresponding part, such as picture downloading, of the printing data that are sent by the main control board 1, and outputs a drive signal to a corresponding group of printing heads, such as 4-1, in the plurality of groups of printing heads.

Step 4: Each of the plurality of groups of printing heads, for example, the printing head 4-1, responds to the drive signal outputted by the corresponding drive board 2-1, and simultaneously performs jet printing for a to-be-printed character of the corresponding part, such as picture downloading, to implement quick spliced printing.

Further, the following step is included: The communication modules on the main control board collect the working statuses of the 16 drive boards in real time. When all the drive boards are ready, the communication modules send a start command, and add data verification or verified data, thereby ensuring data reliability. However, in consideration of a possible delay or block during communication, the drive board performs a printing operation or controlling based on a level signal of the synchronization module on the main control board. In addition, because level signals of the 16 drive boards are sent by the same main control board, asynchronous printing caused by different clock signals between different board cards can be avoided. The TTL signal is easy to be interfered. The communication modules on the main control board perform data verification with the drive boards aperiodically. Once a large fluctuation occurs, the system alarms, and finds a problem in time, to avoid a subsequent loss.

The foregoing method for driving the valve-type inkjet apparatus corresponds to the drive system for the row-connected inkjet apparatus provided in this application. Various modules in the system respectively perform the steps in the foregoing method for driving the row-connected inkjet apparatus, and details are not described herein again.

The main control board is added, and communications and a signal synchronization technology are optimized, so that a high-precision spliced and coordinated jet printing operation of a plurality of inkjet apparatuses is implemented, to achieve effects that can be at least implemented by the drive system for the row-connected inkjet apparatus and the method provided in the embodiments of this application. Linkage of the communication module and the synchronization module in this application can implement spliced printing of, for example, 16 inkjet devices, so that an application range is greatly expanded One main control board is added, so that printing parameters of the 16 drive boards may be set by using the host computer with only one communications interface. The main control board simultaneously manages printing time sequences of the 16 groups of printing heads, so that misplacement of a printing location caused by asynchronized clocks of the different drive boards is avoided.

### Embodiment 5

This embodiment is shown in FIG. 1 and FIG. 4. FIG. 1 is a schematic diagram of a drive system for a row-connected inkjet apparatus according to an embodiment of this application. FIG. 4 is a schematic diagram of circuit control of a drive board in a drive system according to this application.

The drive system includes the plurality of drive boards such as 2-1, . . . , and 2-16. In this embodiment, this application is described by mounting 32 waveform switching circuits on 32 drive boards, including: three pulse-width modulators, 32 waveform switching circuits, a control-signal output circuit, and 32 drive circuits correspondingly controlling 32 groups of printing heads. The three pulse-width modulators 10 include pulse-width modulators 01-1, 01-2, and 01-3. The 32 waveform switching circuits 20 include waveform switching circuits 02-1, 02-2, . . . , and 02-32. There is the control-signal output circuit 05. The 32 drive circuits 30 include drive circuits 03-1, 03-2, . . . , and 03-32. The 32 groups of printing heads 4 include printing heads 4-1, 4-2, . . . , and 4-32.

The three pulse-width modulators include the first pulse-width modulator 01-1, the second pulse-width modulator 01-2, and the third pulse-width modulator 01-3.

Each of the first pulse-width modulator 01-1, the second pulse-width modulator 01-2, and the third pulse-width modulator 01-3 is electrically connected to the plurality of waveform switching circuits 02-1, 02-2, . . . , and 02-32. The 32 waveform switching circuits 02-1, 02-2, . . . , and 02-32 are respectively connected to the 32 drive circuits 03-1, 03-2, . . . , and 03-32. The 32 drive circuits 03-1, 03-2, . . . , and 03-32 are respectively electrically connected to the 32 groups of printing heads 4-1, 4-2, . . . , and 4-32, to drive the 32 groups of printing heads to implement printing.

An output end of the control-signal output circuit 05 is respectively electrically connected to the plurality of waveform switching circuits 02-1, 02-2, . . . , and 02-32, to respectively provide independent control information or signals to the plurality of waveform switching circuits 02-1, 02-2, . . . , and 02-32. The 32 groups of spray printing heads form a spraying-head array. The printing head further controls a working status of the printing head by using a built-in solenoid valve, and the control-signal output circuit communicates with the host computer.

The control information includes information about a time point and a waveform provided by a corresponding pulse-width modulator, to enable the waveform switching circuit to switch, at the time point, the drive waveform to a pulse waveform provided by the corresponding pulse modulation.

Preferably, the three pulse-width modulators respectively output three different waveforms. A waveform 1 is a waveform whose duty cycle is greater than or equal to 80% and less than or equal to 98%, a waveform 2 is a waveform whose duty cycle is greater than or equal to 12% and less than or equal to 28%, and a waveform 3 is an inverse waveform whose duty cycle is greater than or equal to 12% and less than or equal to 29%. A negative bias accelerates resetting of the printing head. Different duty cycles of the waveforms are used to at least achieve one of effects such as energy saving, reducing energy consumption, reducing power consumption by using the low duty cycle, reducing heat generation, and increasing life.

Each of the three pulse-width modulators provides or outputs pulse waveforms at three different phases to at least 32 waveform switching circuits, and the control-signal output circuit provides at least 32 pieces of different control information and respectively sends the control information to the at least 32 waveform switching circuits.

The at least 32 waveform switching circuits receive the three waveforms sent by the three pulse-width modulators.

The at least 32 waveform switching circuits receive the at least 32 pieces of control information sent by the control signal output circuit, switch three waveforms based on parameters set based on the control information, for example, at different time points, and provide the three switched waveforms as drive waveforms for corresponding drive circuits, or send at least 32 switched control signals to the at least 32 drive circuits.

The at least 32 drive circuits receive the three switched waveforms or the at least 32 control signals that are sent by the at least 32 waveform switching circuits, drive the three switched or selected waveforms (the drive waveforms) or the at least 32 control signals to amplify an output signal, and send the output signal to the at least 32 groups of printing heads.

The at least 32 groups of printing heads perform printing based on the at least 32 signals respectively received, to independently control the at least 32 groups of printing heads.

The controlling the 32 groups of printing heads 4 further includes setting and controlling the waveform switching circuit by using software, to provide a wave control modeling signal or information to the 32 groups of printing heads 4. Independent and fine spraying-head controlling performed by using the waveform is implemented, problems that duration control is limited and it is difficult to control a current and a voltage are resolved, and independent controlling that is fine or consistent is implemented.

Further, the control signal output circuit further performs data communication with the host computer, and receives a control signal, character data, and picture data sent by the host computer. The plurality of waveform switching circuits use a plurality of multiplexers. Independent and fine spraying-head controlling performed by using the waveform is implemented, problems that duration control is limited and it is difficult to control a current and a voltage are resolved, and independent controlling that is fine or consistent is implemented.

### Embodiment 6

This embodiment shows an electronic component mainly used on the drive board of the inkjet apparatus and a connection relationship of the electronic component.

In some implementations, the plurality of pulse-width modulators at least use a pulse-width modulation chip. The plurality of waveform switching circuits at least use an integrated analog switch. The plurality of drive circuits at least use a driver. The plurality of groups of printing heads at least use a MOS transistor. An output pin of the pulse-width modulation chip is connected to an input pin of the integrated analog switch. An output pin of the integrated analog switch is connected to an input pin of the driver. An output pin of the driver is connected to a gate of the MOS transistor. A drain of the MOS transistor is connected to the plurality of groups of printing heads. Preferably, to implement functions, the pulse-width modulator uses a chip M451. To implement main functions, the waveform switching circuit at least use an integrated analog switch SN74LVC1G126DBV. The drive circuit uses a driver MCP1416. The printing head at least uses a MOS transistor NCE6020AK. A PWM output pin of the pulse-width modulation chip M451 is connected to an input pin of the analog switch. An output pin of the analog switch is connected to an input pin of the driver MCP1416. An output pin of the MCP1416 is connected to a gate of the MOS transistor. A drain of the MOS transistor is connected to the printing head.

### Embodiment 7

This embodiment shows that the drive system of this application selects and matches a waveform with corresponding ink. The drive system of this application has applicability to different printing materials, and can improve compatibility of a printer head and a printing effect. As shown in Table 1, different waveforms of the apparatus of this application preferably match corresponding ink.

Table 1 shows different waveforms of the apparatus of this application and preference matches of corresponding ink.

| | Ink property | | Second pulse-width | | First pulse-width | | Third pulse-width | |
|---|---|---|---|---|---|---|---|---|
| | parameter | | modulator | | modulator | | modulator | |
| | | Surface | | Duty | | Duty | | Duty |
| Ink | Viscosity | tension | Frequency | cycle | Frequency | cycle | Frequency | cycle |
| name | (cps) | (mN/m) | (Hz) | (%) | (Hz) | (%) | (Hz) | (%) |
| Ink 1 | 2.5 | 23 to 25 | 1000 | 12.5 | 1000 | 70 | 1000 | 12 |
| Ink 2 | 4.9 | 27 to 29 | 1000 | 20 | 1000 | 80 | 1000 | 12 |
| Ink 3 | 14.5 | 24 to 27 | 600 | 30 | 600 | 80 | 600 | 12 |
| Ink 4 | 5.7 | 23 to 25 | 600 | 15 | 600 | 70 | 600 | 12 |

In the foregoing embodiment, the ink 1 is referred as “waterborne black ink”. The ink 2 is referred to as “waterborne white ink”.

The ink 3 is referred to as “waterborne high-adhesion white ink”. The ink 4 can be purchased on the market under a name of “waterborne white ink” based on a property parameter of the ink 4. There may be a plurality of first pulse-width modulators and second pulse-width modulators in this application, and the first pulse-width modulators and the second pulse-width modulators respectively correspond to ink having different viscosities and surface tensions.

During actual application, the switching circuit needs to automatically select an appropriate waveform based on factors such as a characteristic of a printing material and a blocking degree of the printing head, to ensure printing quality. Optionally, the printing material is printing ink, and the printing ink includes new materials such as a pigment, medicine, a binder, and nano silver. A person skilled in the art should further realize that, in combination with the embodiments herein, units and algorithm, steps of each example described can be implemented with electronic hardware, computer software, or the combination thereof. In order to clearly describe the interchangeability between the hardware and the software, compositions and steps of each example have been generally described according to functions in the foregoing descriptions. Whether the functions are performed by hardware or software depends on particular applications and design constraints of the technical solutions. A person skilled in the art can use different methods to implement the described functions for each particular application, but it should not be considered that the implementation goes beyond the scope of the embodiments of the present disclosure.

In combination with the embodiments disclosed herein, steps of the method or algorithm described may be implemented using hardware, a software module executed by a processor, or the combination thereof. The software module may be placed in a random access memory (RAM), a memory, a read-only memory (ROM), an electrically programmable ROM (EPROM), an electrically erasable programmable ROM (EEPROM), a register, a hard disk, a removable magnetic disk, a CD-ROM, or any storage medium of other forms well-known in the technical field.

The foregoing specific implementations further describe the objectives, technical solutions in detail, and beneficial effects of the embodiments of the present disclosure. It should be appreciated that the foregoing descriptions are merely specific implementations of the embodiments of the present disclosure, but are not intended to limit the protection scope of the embodiments of the present disclosure. Any modification, equivalent replacement and improvement made without departing from the spirit and principle of the embodiments of the present disclosure shall fall within the protection scope of the embodiments of the present disclosure.

Exemplary embodiments of the present disclosure are specifically shown and described above. It should be understood that the present disclosure is not limited to the detailed structures, setting manners, or implementations described herein. On the contrary, the present disclosure is intended to cover various modifications and equivalent settings included in the spirit and scope of the appended claims.

What is claimed is:

1. A drive system for a row-connected inkjet apparatus, wherein the system comprises a main control board, a plurality of drive boards, a plurality of groups of printing heads corresponding to the plurality of drive boards, a plurality of synchronization modules, and a plurality of communication modules;
the main control board sending, to the plurality of drive boards by using the plurality of synchronization modules, synchronization information of printing time sequences for controlling the plurality of groups of printing heads;
the main control board sending printing data to the plurality of drive boards by using the plurality of communication modules;
each of the plurality of drive boards receiving the synchronization information of the printing time sequences and a corresponding part of the printing data that are sent by the main control board, and outputting a drive signal to a corresponding printing head based on the synchronization information of the printing time sequences and the corresponding part of the printing data that are received; and
each of the plurality of groups of printing heads responding to the drive signal outputted by the corresponding drive board, and simultaneously performing jet printing for the corresponding part of the printing data, to implement quick spliced printing.

2. The drive system for the row-connected inkjet apparatus according to claim 1, wherein the main control board controls 2 to 40 synchronization modules and 2 to 40 communication modules, a quantity of the plurality of drive boards ranges from 2 to 40, and a quantity of the plurality of groups of printing heads ranges from 2 to 40, to print a character whose width exceeds 32 dots.

3. The drive system for the row-connected inkjet apparatus according to claim 1, wherein the printing data comprises a setting parameter, an adjustment parameter, an inkjet speed, character data, verified data, time sequence information, and a picture; and the drive signal comprises a drive voltage.

4. The drive system for the row-connected inkjet apparatus according to claim 3, wherein a range of the adjustment parameter is at least one or more combinations of number information of the printing heads, adjustment information of a spacing between the printing heads, printing delay information of the printing heads, and printing direction information of the printing heads, to implement alignment, synchronization, or consistency of the printing data.

5. The drive system for the row-connected inkjet apparatus according to claim 1, wherein the inkjet speeds of the plurality of groups of printing heads are adjustable, to control a spacing between characters printed by each group of printing heads.

6. The drive system for the row-connected inkjet apparatus according to claim 1, wherein the system further comprises a host computer, the host computer being connected to or in data communication with the main control board, the main control board being connected to the plurality of drive boards, the plurality of drive boards being connected to the plurality of corresponding groups of printing heads, and the synchronization modules and the communication modules being integrated on the main control board.

7. The drive system for the row-connected inkjet apparatus according to claim 1, wherein the plurality of drive boards perform printing control based on level signals in the synchronization modules, and the level signals of the plurality of drive boards are sent by the same main control board.

8. The drive system for the row-connected inkjet apparatus according to claim 1, wherein the drive board comprises a plurality of pulse-width modulators, a plurality of waveform switching circuits, a plurality of drive circuits, and a control-signal output circuit;
the plurality of pulse-width modulators respectively outputting different pulse waveforms, and each of the pulse-width modulators being connected to all the waveform switching circuits; and
the plurality of waveform switching circuits selecting or switching a pulse waveform from the plurality of pulse-width modulators based on control information provided by the control-signal output circuit, and providing the pulse waveform as a drive waveform to a corresponding drive circuit, to enable the drive circuit to drive, based on the drive waveform, a corresponding printing head to perform a printing operation.

9. The drive system for the row-connected inkjet apparatus according to claim 8, wherein the control information comprises information about a time point and a corresponding pulse-width modulator, to enable the waveform switching circuit to switch, at the time point, the drive waveform to a pulse waveform provided by the corresponding pulse modulation, each pulse waveform being a square wave.

10. The drive system for the row-connected inkjet apparatus according to claim 8, wherein the plurality of pulse-width modulators comprise three pulse-width modulators, and the three pulse-width modulators respectively output three different pulse waveforms, comprising a start waveform, a retaining waveform, and a release waveform, a duty ratio of the start waveform being greater than a duty ratio of the retaining waveform, and the release waveform being an inverse waveform.

11. A row-connected inkjet apparatus, comprising the drive system for the row-connected inkjet apparatus according to claim 1.
